(19) United States
(12) Patent Application Publication
(10) Pub. No.: US 2016/0279017 A1
(43) Pub. Date: Sep. 29, 2016

(54) ROLLER THERAPY DEVICE

(71) Applicant: Recoup Fitness LLC, Littleton, CO (US)

(72) Inventors: Matthew Hyder, Littleton, CO (US); Jeffrey Ballard, Littleton, CO (US)

(21) Appl. No.: 15/078,241

(22) Filed: Mar. 23, 2016

Related U.S. Application Data
(60) Provisional application No. 62/136,793, filed on Mar. 23, 2015.

(51) Int. Cl. A61H 15/00

(52) U.S. Cl. CPC A61H 15/00; A61H 2015/0064

(57) ABSTRACT

The herein disclosed technology provides a roller therapy device including a ball and a dual-component casing with components that mate together on opposite sides of the ball to rotatably secure the ball. In one implementation, the dual-component casing includes a cap portion with a cavity sized and shaped to receive the ball and an annular portion that can be selectably attached to and detached from a mouth of the cavity after the ball is positioned in the cavity. When connected in such manner, the ball protrudes through and aperture in the annular portion and is freely rotatable relative to the dual-component casing.

### CROSS-REFERENCE TO RELATED APPLICATIONS

The present application claims benefit of priority to U.S. Provisional Application No. 62/136,793, entitled “The Stinger Handle” and filed on Mar. 23, 2015. This application is specifically incorporated by reference for all that it discloses or teaches.

### BACKGROUND

Existing fitness recuperation and massage therapy devices can be cumbersome to use and non-adaptable for massage of hard to reach places and/or different types of massage.

### SUMMARY

Implementations disclosed herein provide for a roller therapy device and methods for using a roller therapy device. According to one implementation, a roller therapy device includes a ball securable within a dual-component casing. The dual-component casing includes a cap portion with a cavity sized and shaped to receive the ball and an annular portion selectably attachable to and detachable from a mouth of the cavity. When the ball is placed within the cavity and the annular portion is secured to the cap portion, a portion of the ball protrudes through an aperture in the annular portion and the ball is freely rotatable relative to the dual-component casing.

According to another implementation, a method for using a roller therapy device includes positioning a ball within a cavity formed in a cap portion of a casing, aligning an annular portion of the casing with a mouth of the cavity such that the ball is between the annular portion and the cap portion, and attaching the annular portion to the cap portion such that the annular portion forms a perimeter contacting a mouth of the cavity. When the annular portion is attached to the cap portion, a portion of the ball protrudes through an aperture of the annular portion and the ball freely rotatable relative to the cap portion and the annular portion.

This Summary is provided to introduce a selection of concepts in a simplified form that are further described below in the Detailed Description. This Summary is not intended to identify key features or essential features of the claimed subject matter, nor is it intended to limit the scope of the claimed subject matter. These and various other features and advantages will be apparent from a reading of the following Detailed Description.

### BRIEF DESCRIPTIONS OF THE DRAWINGS

FIG. 1 illustrates a side view of an example roller therapy device.

FIG. 2 illustrates an expanded view of an example roller therapy device.

FIG. 3 illustrates a cross-sectional view of another example roller therapy device.

FIG. 4 illustrates a cross-sectional view of an example component suitable for use within a roller therapy device.

FIG. 5 illustrates a perspective view of an example annular component suitable for use within a roller therapy device.

FIG. 6 illustrates a side perspective view of another example roller therapy device.

FIG. 7 illustrates a bottom perspective view of yet another example roller therapy device.

FIG. 8 illustrates example operations for using a roller therapy device according to one or more implementations of the presently disclosed technology.

### DETAILED DESCRIPTION

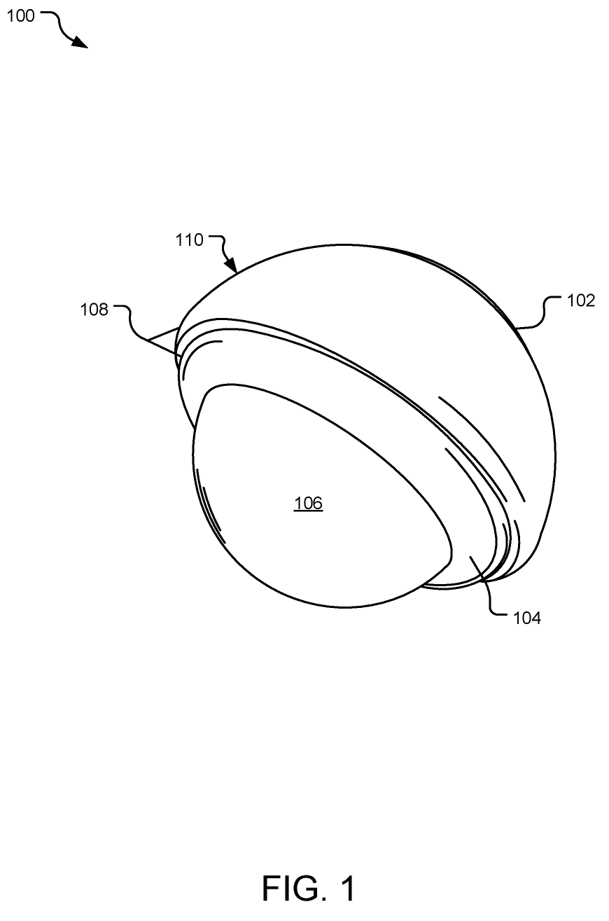

FIG. 1 illustrates a side perspective view of an example roller therapy device 100. The roller therapy device 100 includes at least a ball 106 and a casing 108 including a cap portion 102 that attaches to an annular portion 104. In use, the ball 106 may be secured in a cavity of the cap portion 102 by the annular portion 104 in a manner that prevents the ball 106 from disengaging from the cap portion 102, but permits the ball 106 to rotate relative to the casing 108. In one example operation of use, a user grips an exterior surface 110 of the cap portion 102 and places the ball 106 into contact with a user (e.g., skin or clothing). If the user applies pressure while moving the roller therapy device 100 against the user, the ball 106 rotates against an interior surface of the cap portion 102, massaging muscles at or proximal to the area of contact.

In one implementation, the cap portion 102 and the annular portion 104 are selectively engagable and disengagable, and a user can optionally remove the ball 106 from the casing 108 and/or use the various components of the roller therapy device 100 independent of one another. For example, the ball 106 can be used for massage therapy independent of the casing 108, such as a rubbing or rolling tool for massaging (e.g., “rolling out”) hips, hamstrings, shins, etc. Alternatively, a user may place the ball 106 between the user and a wall or floor and move relative to the wall or floor to roll the ball and/or to apply pressure to a target muscle group. In still another implementation of use, the ball 106 can be removed from the casing 108, and the casing 108 or a portion thereof (e.g., the cap portion 102) can be placed against a wall and used to rub out a user's back or other body part. The simplicity of attachment and detachment of the various components of the roller therapy device 100 makes it a convenient tool that is adaptable for a wide range of types of massage and muscle relief.

In one implementation, the ball 106 is filled with a substance designed to resist changes in temperature to keep the ball 106 cold or warm. For example, the ball 106 may be filled with a gel, liquid, and/or solid that can be heated or chilled and thereafter resistant to further changes in temperature. In some implementations, the ball is filled with a cooling material. As used herein, the term ‘cooling material’ refers to a material with a high specific heat that, once chilled, heats relatively slowly, such as compared to air. For example, a volume of cooling material warms more slowly than an equal volume of air that is initially at the same temperature when both are placed in a hot environment. In one implementation, the term “cooling material” refers to any material with a specific heat at or higher than water (e.g., 1 calories/gram ° C.).

In various implementations, cooling materials may assume a variety of forms including without limitation various gels, liquid, solids and combinations thereof. A variety of substances may be suitable for use within cooling materials (e.g., solutions), including without limitation glycols, such as ethylene and propylene glycol; glycerin and glycol-ethers, such as ethyl-cellosolve (2-ethoxyethanol), butyl-cellosolve ethanol), butyl-carbitol (2-(butoxyethoxy) ethanol), diethylene glycol and triethylene glycol; and alcohols, such as butyl, amyl, ethyl, or methyl alcohol. In one example implementation, the ball 106 is filled with a cooling material that, when frozen (e.g., two hours in a freezer) may remain cold to the touch for an extended period of time (e.g., up to six additional hours) within a room temperature environment.

Although the size and shape of the casing 108 may vary in different implementations, the casing 108 is, in one implementation, sized to be easily gripped by a user's hand. Example dimensions and design details are discussed below with respect to the following figures.

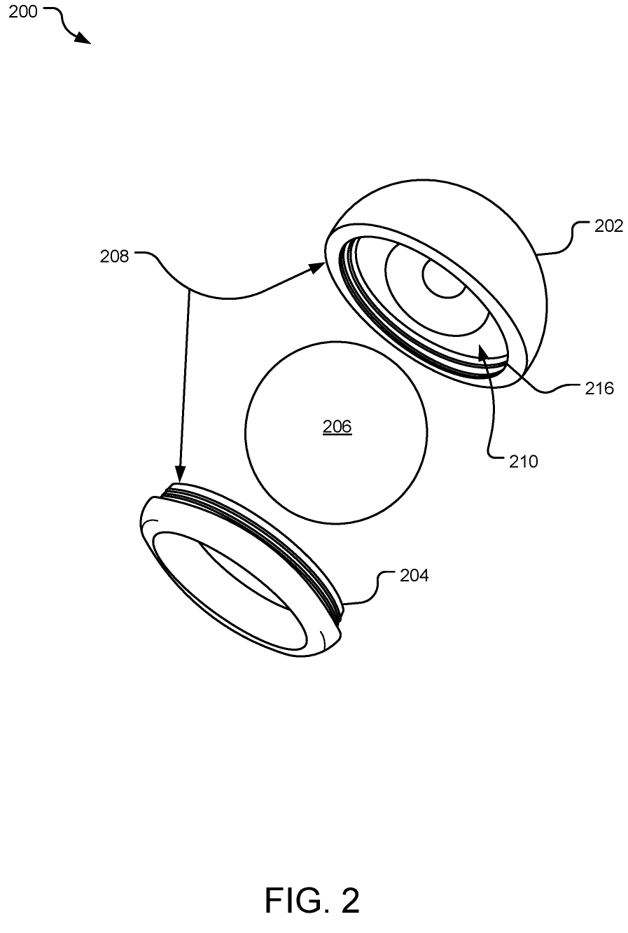

FIG. 2 illustrates an expanded view of an example roller therapy device 200. The roller therapy device 200 includes a ball 206 and a casing 208 including a cap portion 202 that attaches to an annular portion 204 on opposite sides of the ball 206, as shown. The cap portion 202 includes a cavity 210 sized and shaped to receive and cradle the ball 206. The annular portion 204 has an aperture with a maximum diameter slightly less than a maximum diameter of the ball such that the annular portion 204 is usable to secure the ball 206 within the cavity 210. When the annular portion 204 is attached to the cap portion 202, the annular portion 204 forms a perimeter seal about a mouth 216 of the cavity, and the ball 206 is retained within the casing 208 with an end portion protruding through the annular portion 204 (e.g., as shown in FIG. 1).

Although dimensions of the roller therapy device 200 may vary in different implementations, the cavity 210 has a maximum diameter (e.g., from side-to-side of the mouth 216) that is larger than the maximum diameter of the ball 206. In some implementations, sidewalls of the cavity 210 within the cap portion 202 are curved to match a curvature of the ball 206 and/or formed of a rigid material to provide a hard, smooth surface for the ball 206 to roll against. In other implementations, the cavity 210 assumes other shapes that provide the ball 206 with enough space to rotate within the cavity 210.

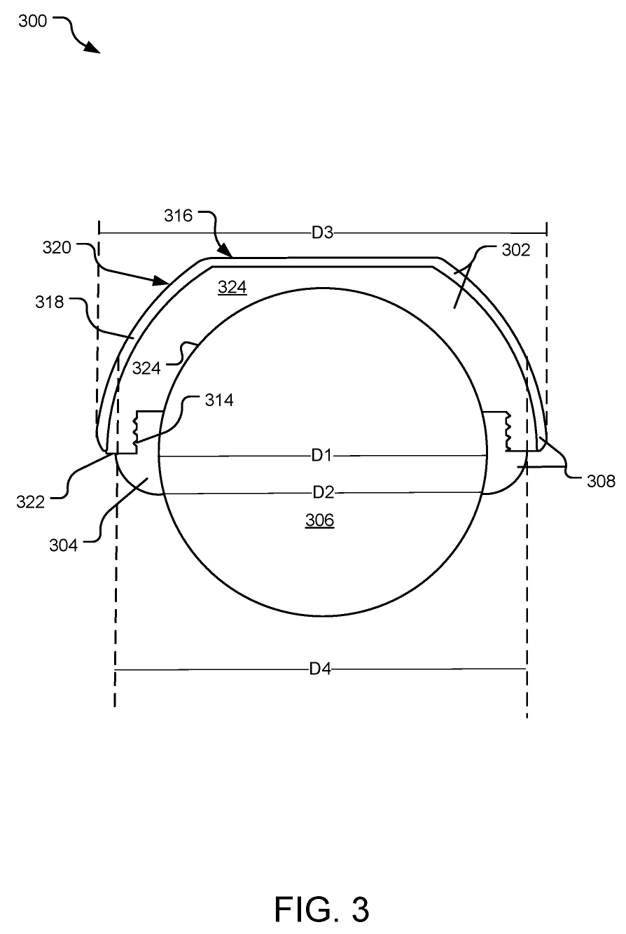

FIG. 3 illustrates a cross-sectional view of another example roller therapy device 300. The roller therapy device 300 includes a ball 306 secured within a dual-component casing 308. The dual-component casing 308 includes an annular portion 304 and a cap portion 302 that can be selectively attached and detached from one another. When the annular portion 304 is attached to the cap portion 302, as shown, the ball 306 is free to rotate relative to the casing 308 and against a smooth interior surface of the cap portion 302.

Although different implementations may utilize different types of engagement mechanisms, the annular portion 304 of FIG. 3 includes outward-facing threads 314 formed about an exterior perimeter. These outward-facing threads 314 are sized and shaped to correspond to grooves formed on an inner surface of the cap portion 302, as shown. In lieu of threading, other implementations may utilize other attachment techniques and mechanisms, including without limitation latches, snaps, toggles, etc.

To ensure that the ball 306 may be secured within the casing 308, a maximum diameter of the ball D1 may slightly exceed a diameter D2 of an aperture in the annular portion 304. In one implementation, the difference in diameters between D1 and D2 is on the order of a few millimeters (e.g., 2-10 mm). For example, D1 may be about 80 mm while D2 is about 77 mm. In various implementations, the diameter D1 may vary considerably. For example, D1 may range between about 50 mm to 120 mm in some implementations.

During use, the cap portion 302 acts as a handhold for a user to grip while massaging a target area with the roller therapy device 300. An outermost diameter D3 of the cap portion 302 is sized to be easily gripped by a single hand. For example, the average male or female may be able to wrap a single hand around the entirety or majority of a cap exterior 318. In various implementations, the outermost diameter D3 ranges between about 80 and 150 mm. For example, the outermost diameter D3 may be about 110 mm and the curvature of the cap portion 302 may allow the cap portion 302 to be easily gripped by most adult human hands. In another implementation, the outermost diameter D3 is between about 120 mm and 150 mm. As used herein, terms of degree such as “about” and “substantially” are intended to denote values and ranges within +/−10 percent of those supplied.

Although other designs are contemplated, an outermost perimeter D4 of the annular portion 304 is, in FIG. 3, slightly smaller than the outermost diameter D3 of the cap portion 302. This design provides a slight ledge 322 between the annular portion 304 and cap portion 302 that may enhance a user's grip. In one implementation, the outermost diameter D3 of the cap portion 302 is on the order of about 5 to 15 mm larger than the outermost perimeter D4 of the annular portion 304.

Although a variety of shapes and sizes are contemplated, the cap exterior 318 of FIG. 3 is generally hemispherical, and includes a rounded sidewall 320 and a flat base surface 316. The flat base surface 316 provides a stabilizing surface on which to rest the roller therapy device 300 when it is not in use. Alternatively, a user can orient the assembled roller therapy device 300 such that the flat base surface 316 is in contact with a wall and such that the ball 306 is in contact with the user's back. By leaning toward the wall and moving (e.g., up, down, left right) to roll the ball 306, one can massage hard-to-reach back muscles without help from another person. In other implementations, the cap portion 302 does not include the flat base surface 316. For example, the curvature of the sidewall 320 may be continued across the entire surface of the cap exterior 318.

In different implementations, the casing 308 may be constructed of a variety of suitable materials, including without limitation various rubbers and plastics such as high-density polyethylene (HDPE), low-density polyethylene (LDPE), ultra-high-molecular-weight polyethylene (UHMWPE), acrylonitrile butadiene styrene (ABS), polyvinyl chloride (PVC), acrylic, polypropylene, polycarbonate, various thermoplastic elastomers (TPEs), thermoplastic polyurethane (TPU), various non polymer materials such as aramid fiber (i.e., Kevlar), and composite materials such as fiberglass, carbon fiber, etc. In one implementation, both the cap portion 302 and the annular portion 304 are molded out of hard plastic materials that provide a smooth interior surface 324 for the ball 306 to spin against. For example, both cap portion 302 and annular portion 304 may be formed via injection molding techniques.

In FIG. 3, the cap exterior 318 is made of a different material than the rest of the cap portion 302 and the annular portion 304. For example, the cap exterior 318 may include a thin piece of rubber molded or glued to hard interior 324 (e.g., an interior made of a hard plastic). Forming the cap exterior 318 from a soft material, such as rubber, provides traction for improved grip and comfort. In some implementations, the cap exterior 318 is imprinted with ergonomic designs to improve comfort and/or grip, such as bumps, grooves, etc.

The mass of each of the cap portion 302, annular portion 304, and ball 306 may vary in different implementations depending on component size, shape, and material choice. In one implementation, the ball is rigid and not deformable by a pressure applied via the human hand. For example, the ball 306 may be metallic sphere, such as an iron or steel ball. In one implementation, the ball 306 is stainless steel. In other implementations, the ball 306 is made of a hard, non-metallic material, such as a rigid plastic (e.g., solid or hollow) or a dense rubber.

In the same or other implementations, the ball 306 is hollow. For example, the ball 306 may include an internal cavity filled with a substance designed to resist changes in temperature to keep the ball 306 cold or warm, such as a cooling or warming material. In these implementations, a manufacturing process of the roller therapy device 300 may include forming a hole in the ball 306, filling the ball 306 with a cooling or warming material through the hold, and sealing the hole.

In at least one implementation, the casing 308 is relatively lightweight as compared to the ball 306 to facilitate ease of use while still be capable of supplying adequate massage pressure. For example, the casing 308 may contribute to about or less than 30% to the total weight of the roller therapy device 300. A few non-limiting example masses and volumes are provided in table 1, below.

TABLE 1
Table of Example Masses and Volumes

| Part | Mass (g) | Volume (mm³) |
|---|---|---|
| Cap Exterior (318) | 44.1 | 44100 |
| Cap interior (324) | 189 | 145000 |
| Annular portion (304) | 47.7 | 36700 |
| Total | 281 | 225800 |

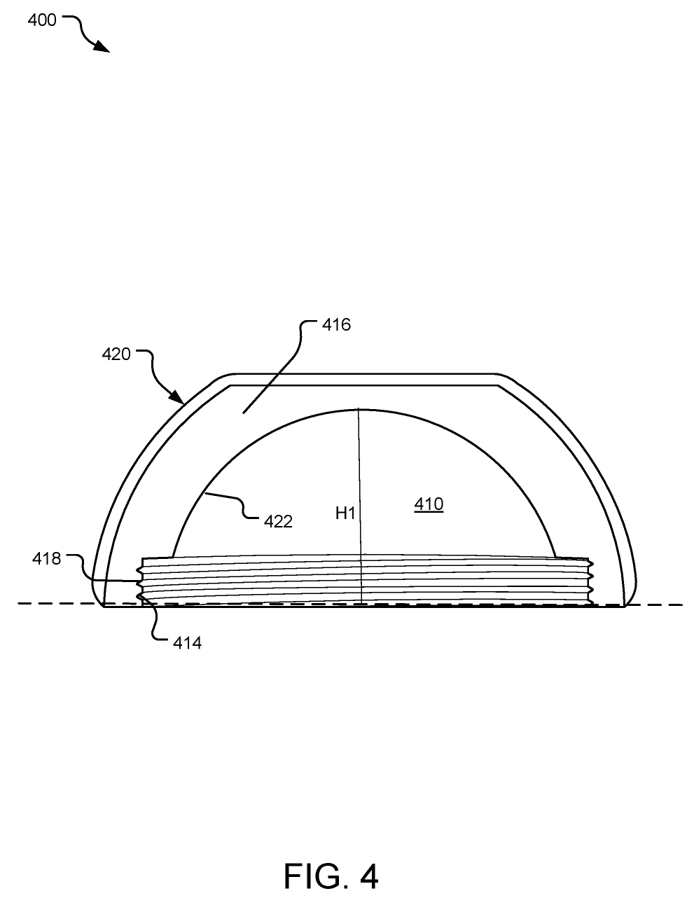

FIG. 4 illustrates a cross-sectional view of an example capping component 400 suitable for use within a roller therapy device according to one or more implementations of the presently disclosed technology. The capping component 400 includes a cavity 410 sized and shaped to receive a ball (not shown). In one implementation, a depth (H1) of the cavity 410 is between about 100% and 150% of a maximum radius of the ball. In another implementation, the depth H1 of cavity 410 is less than or substantially equal to the maximum radius of the ball. In still another implementation, the depth H1 of the cavity 410 is less than the radius of the ball, and a corresponding component (e.g., the annular portion 304 of FIG. 3) has a depth from a top-most point to a bottom-most point that is greater than about half the radius of the ball.

A mouth 414 of the cavity 410 is grooved (e.g., grooves 418) to receive and securely couple (e.g., screw in) to complementary threaded protrusions in a complementary casing component, such as the annular portion 304 of FIG. 3. In this manner, the ball can be secured within the cavity between the capping component 400 and the complementary casing component (not shown). The number, depth, and spacing of the grooves 418 may vary in different implementations. In some implementations, the capping component 400 includes threaded protrusions at the mouth 414 rather than the grooves 418.

In one implementation, the capping component 400 acts as a handle, providing an easily-to-grip exterior surface 420 for controlling pressure and movement of the roller therapy device. An interior portion 416 of the capping component 400 is made of a rigid material and provides a smooth surface 422 of the cavity 410 for the ball to roll against.

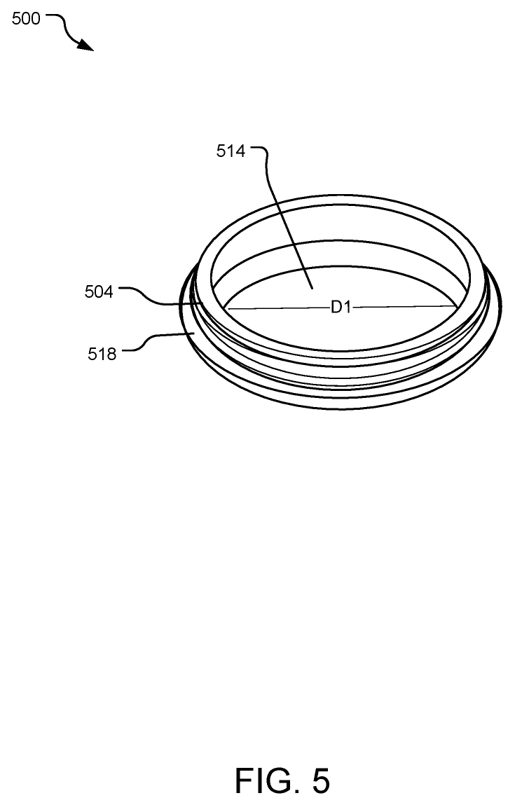

FIG. 5 illustrates a perspective view of an example annular component 500 suitable for use within a roller therapy device according to one or more implementations of the presently disclosed technology. The annular component 500 includes a solid perimeter with outward-facing threads 504 formed about a large central aperture 514. The outward-facing threads 504 permit the annular component 500 to mate with another component (e.g., the capping component 400 in FIG. 4) and to rotatably secure a ball (not shown) between the two components. For example, the outward-facing threads 504 may be sized and shaped to mate with grooves formed in the mouth of the capping component 400 of FIG. 4.

In one implementation, the aperture 514 has a central diameter D1 that is smaller than a maximum diameter of the ball, but large enough to allow some portion of the ball to protrude through the aperture 514. The annular component 500 further includes a lipped lower portion 518 with a slightly larger maximum diameter than an upper portion of the annular component 500 including the outward-facing threads 504. This offset in relative diameters provides a lipped surface that stabilizes a seal between annular component 500 and the complementary component.

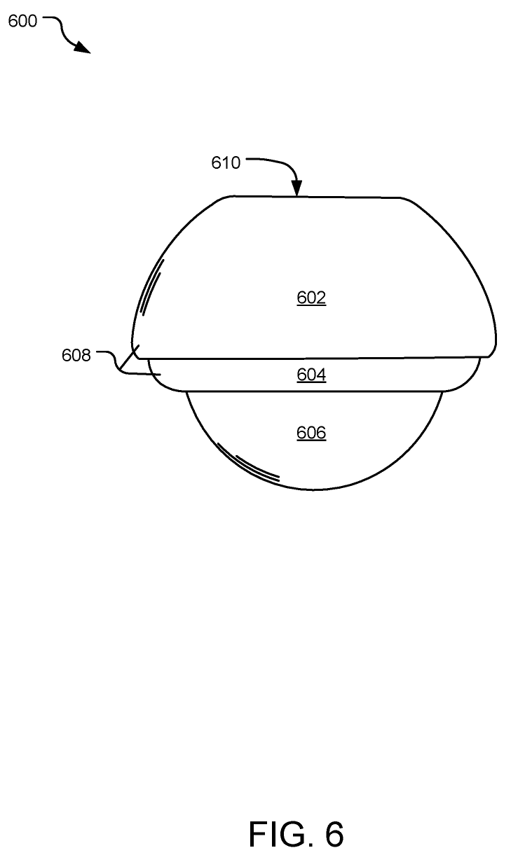

FIG. 6 illustrates a side perspective view of still another example roller therapy device 600. The roller therapy device 600 includes at least a ball 606 and a casing 608 including a cap portion 602 that attaches to an annular portion 604. In use, the ball 606 may be secured in a cavity of the cap portion 602 by the annular portion 604 in a manner that prevents the ball 606 from disengaging from the cap portion 602, but permits the ball 606 to rotate relative to the casing 608 and against a hard interior surface of the cap portion 602. The cap portion 602 includes a flat base surface 610 that provides stabilization and facilitates massage of hard to reach places, such as a user's back. For example, the roller therapy device 600 may be placed between a wall and a user with the flat base surface 610 stabilizing the roller therapy device 600 against the wall while the user presses against the ball 606, massaging the back. Other aspects of the roller therapy device 600 may be the same or similar to those described elsewhere herein with respect to other implementations.

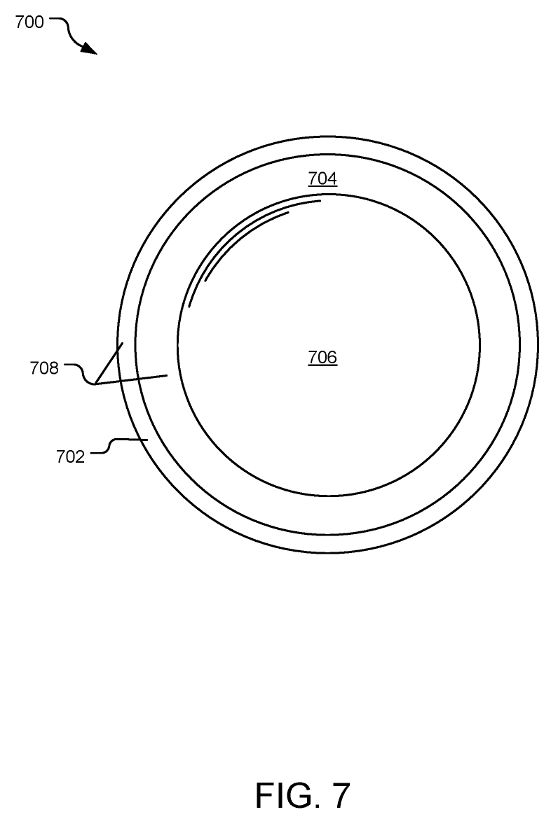

FIG. 7 illustrates a bottom perspective view of another example roller therapy device 700. The roller therapy device 700 includes at least a ball 706 and a casing 708 including a cap portion 702 that attaches to an annular portion 704. In use, the ball 706 may be secured in a cavity of the cap portion 702 by the annular portion 704 in a manner that prevents the ball 706 from disengaging from the cap portion 702, but permits the ball 706 to rotate relative to the casing 708 and against a hard interior surface of the cap portion 702. Other aspects of the roller therapy device 700 may be the same or similar to those described elsewhere herein with respect to other implementations.

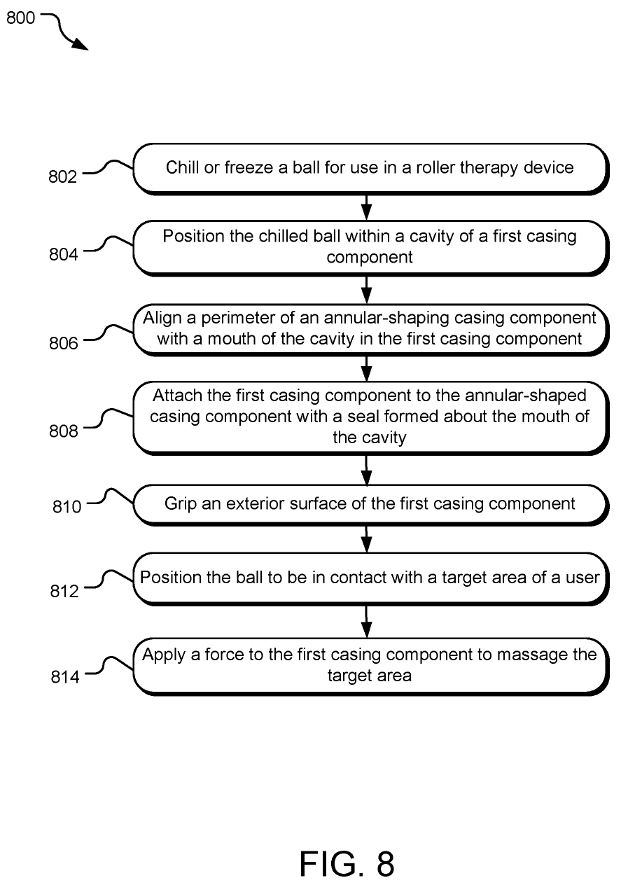

FIG. 8 illustrates example operations 800 for using a roller therapy device according to the presently-disclosed technology. A cooling operation 802 cools a ball prior to using the ball for a roller therapy application. To cool the ball, a user may place it in a cold environment, such as a freezer or refrigerator until the ball is cool or cold to the touch (e.g., at or below about 32 degrees Fahrenheit). In one implementation, the ball is filled with a cooling material. In another implementation, the ball is constructed of one or more materials that are good conductors. In still another implementation, the ball includes one or more layers of insulating material.

In some instances of use, the cooled ball can be used for roller therapy independent of any other components. For example, a user may ‘roll out’ a muscle by applying pressure while moving the ball (e.g., rolling, stationary pushing) against a target area (e.g., shins, hips, back, shoulders, harms, hamstrings, etc.)

A positioning operation 804 positions the ball within a cavity formed in a first casing component. Sizes and dimensions of the cavity may vary in different implementations and/or be defined in accordance with other example features described herein. In one implementation, the cavity has a curvature that matches a curvature of the ball (e.g., a sphere with a radius that is <1-2 mm bigger than a radius of the ball). The maximum depth of the cavity may vary based on the size of other casing components, but is, in one implementation, larger than the radius of the ball but less than the full diameter of the ball (e.g., between 100 and 150% of the radius of the ball).

An alignment operation 806 aligns a perimeter of an annular-shaped casing component with a mouth of the cavity in the first casing component so that an aperture of the annular-shaped casing component aligns with an approximate center of the cavity. During the alignment operation, the ball is between the annular-shaped casing component and the first casing component.

An attaching operation 808 attaches the annular-shaped casing component to the first casing component such that the annular-shaped component is in contact with the first casing component about a mouth of the cavity and the ball protrudes through the aperture. The attachment operation 808 may be performed in a variety of ways. In one implementation, the annular-shaped casing component is rotated relative to the first casing component to attach threaded protrusions of the annular-shaped casing component to corresponding grooves formed in the first casing component. In other implementations, the attachment operation entails engaging one or more latches, pins, or other locking mechanisms, etc. In one implementation where the ball is not selectably removable from the casing, the first casing component and the annular-shaped casing component are non-removably bonded together, such as via an adhesive.

In one implementation, the first casing component includes a continuous, generally rounded outer surface. For example, the outer surface may be generally hemispherical in shape and/or include a flat base and a continuous rounded sidewall (e.g., as described and illustrated with respect to FIG. 3). In some implementations, the first casing component includes indentations sized and positioned to align with a user's fingers. In still another implementation, the first casing component includes other ergonomic features that promote traction for improved grip and/or comfort. The annular-shaped casing component may assume a variety of shapes and sizes in different implementations but is, in one implementation, generally annular and sized and shaped to secure to the mouth of the cavity formed in the first casing component, as described above.

Once the first casing components is mated to the annular-shaped casing component, as described above, a directional contact force can be applied to rotate the ball relative to the first casing component and the annular-shaped casing component.

During a massage therapy operation, a gripping operation 810 grips an exterior surface of the first casing component and a positioning operation 812 positions the portion of the ball protruding from the annular-shaped casing component to be in contact with a user (e.g., skin or clothing). A force application operation 814 applies a force to the first casing component, and the force is transferred through the ball to a contact area of a user (e.g., an area where the ball is in contact with the user's skin or clothing). When the force is applied has a directional component perpendicular to the user's skin and another directional component generally parallel to the user's skin, the ball rotates against the interior surface of the first casing component and transfers the force to the user, massaging a target area.

The above specification, examples, and data provide a complete description of the structure and use of exemplary embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A roller therapy device comprising:
a ball;
a casing including:
a cap portion with a cavity sized and shaped to receive the ball; and
an annular portion selectably attachable to and detachable from a mouth of the cavity of the cap portion to secure the ball in the cavity between the cap portion and the annular portion such that a portion of the ball protrudes through an aperture in the annular portion and is freely rotatable relative to the casing.

2. The roller therapy device of claim 1, wherein the ball contacts a smooth interior wall of the cap portion when rotating relative to the casing.

3. The roller therapy device of claim 1, wherein the cap portion is generally hemispherical in shape and includes a flat outer surface opposite a base of the cavity.

4. The roller therapy device of claim 1, wherein the cap portion is selectably attachable to the base portion via a threaded engagement.

5. The roller therapy device of claim 1, wherein the aperture in the annular portion has a maximum diameter less than a maximum diameter of the ball.

6. The roller therapy device of claim 1, wherein the ball is filled with a cooling gel and selectably removable from the casing.

7. The roller therapy device of claim 1, wherein the cavity has a spherical curvature.

8. The roller therapy device of claim 1, wherein the cap portion has a maximum diameter less than about 150 mm.

9. The roller therapy device of claim 1, wherein the ball is metal.

10. The roller therapy device of claim 1, wherein a depth of the cavity formed in the cap portion equals or exceeds half of the maximum diameter of the ball.

11. A method comprising:
positioning a ball in a cavity formed in a cap portion of a casing;
aligning an annular portion of the casing with a mouth of the cavity such that the ball is between the annular portion and the cap portion; and
attaching the annular portion to the cap portion such that the annular portion forms a perimeter in contact with the mouth of the cavity and a portion of the ball protrudes through an aperture of the annular portion, the ball freely rotatable relative to the cap portion and the annular portion.

12. The method of claim 11, further comprising:
cooling the ball prior to the positioning operation.

13. The method of claim 11, further comprising:
gripping an exterior surface of the cap portion;
placing the portion of the ball protruding from the casing in contact with a user's skin;
applying force while moving the cap portion to roll the ball against an interior wall of the cap portion and relative to the user's skin and the casing.

14. The method of claim 11, wherein the cap portion is removably attachable to the annular portion via a threaded engagement.

15. The method of claim 11, wherein the ball is filled with a cooling material.

16. The method of claim 11, wherein the cavity has a spherical curvature.

17. The method of claim 11, wherein the ball is metal.

18. The method of claim 11, wherein a depth of the cavity exceeds half of a maximum diameter of the ball.

19. The method of claim 11, wherein the cap portion includes a flat outer surface opposite a base of the cavity.

20. The method of claim 11, wherein the ball contacts a smooth interior wall of the cap portion when rotating relative to the casing.
